(19) United States
(12) Patent Application Publication
(10) Pub. No.: US 2005/0219411 A1
(43) Pub. Date: Oct. 6, 2005

(54) Method of Processing Video Fields and Related Fields Similarity Detection Apparatus

(76) Inventor: Zhi-Ren Chang, Hsin-Chu City (TW)

Correspondence Address: NORTH AMERICA INTERNATIONAL PATENT OFFICE (NAIPC), P.O. BOX 506, MERRIFIELD, VA, 22116, US

(21) Appl. No.: 10/907,447

(22) Filed: Apr. 1, 2005

Related U.S. Application Data
(60) Provisional application No. 60/558,569, filed on Apr. 2, 2004.

(51) Int. Cl. H04N 11/20

(52) U.S. Cl. 348/452; 348/448

(57) ABSTRACT

A method for the processing of video fields is disclosed. The method includes judging similarities of each couple among a plurality of couples of adjacent fields (wherein each couple of fields includes an odd field and an even field; and generated image signals of another format according to a pattern of the similarities and the original video fields. A method of detecting similarities between odd fields and even fields is further disclosed, such that similarities of adjacent interlaced fields can be utilized to judge the format of image source in order to generate progressive high quality frames more efficiently.

### CROSS REFERENCE TO RELATED APPLICATIONS

This application claims the benefit of U.S. Provisional Application No. 60/558,569, filed Apr. 2, 2004, and included herein by reference.

### BACKGROUND OF INVENTION

1. Field of the Invention

This invention relates to a method and related device for processing video fields, more particularly, a method and related fields similarity detection device for processing video fields according to the similarity of a plurality of odd and even fields.

2. Description of the Prior Art

The continuous and dynamic video of a movie or television provided to viewers is in reality generated from a combination of gradually changing static images. In reference to television display, there are two types of television systems. The first one is the national television standard committee (NTSC) system. In this system each video field includes 525 rows of data (i.e., 525 lines) and 60 fields are updated per second, which means the frame rate is 60 Hz. The second system for the display of television images is called the phase alternating line (PAL). In this system each video field includes 625 rows of data and 50 field s are updated each second, which means the frame rate is 50 Hz. The traditional television technology to broadcast 50/60 frames per second having 625/525 rows of data is extremely expensive and difficult. To overcome this problem interlaced scanning technology was developed. Interlaced scanning controls the electron-beam of the television to scan the screen but at the time of first scanning only even lines are scanned instead. Later, in the next scan, the odd lines are scanned. Hence, the field rate of 60 Hz or 50 Hz results in only 30 frames or 25 frames written per second. However, the flow of dynamic images is still acceptable to the human eye. Each frame in the interlaced scanning technology is divided into two parts: odd sequence data known as odd field and even sequence data known as even field.

Other video technology may operate at frame rates different from the television system. For example, movie technology utilizes the general standard is 24 frames scanned per second providing the viewer with a frame rate of 24 Hz. Therefore, in NTSC system, when it is desirable to broadcast a movie onto the television, the movie must be converted from its normal frequency of 24 Hz to 60 Hz. This frequency update is necessary to conform to the standard of television broadcasting.

FIG. 1 illustrates a comparison diagram between television fields converted from the film with original film frames. In upper half portion is the original film frames A, B, C and D. In the lower half portion are ten television fields generated by the original film frames A, B, C and D: F1 to F10, the odd sequence data of each film frame is captured as the odd field, and the even sequence data is captured as the even field. For example, the odd sequence data of film frame A is captured as the television field F1. Ao represents the odd field of film frame A. The even sequence data of the film frame A is captured as the television field F2. Ae represents the even field of film frame A. Similarly, Be/Bo, Co/Ce, and De/Do represent the even sequence data and the odd sequence data of film frames B, C, and D respectively.

The film frame rate is 24 Hz and the field rate of the NTSC system that utilizes interlaced scanning technology is 60 Hz. The prior art helps solve this discrepancy by utilizing two movie frames to form five television fields. In other words, a single movie frame is converted into two or three television fields at each interval. In order to generate interlaced fields, FIG. 1 shows the transformation relationship between the movie and the television fields F1 to F10. Sequentially, odd field Ao, even field Ae, odd field Ao are captured from the film frame A. Similarly, fields Be/Bo, Ce/Co/Ce, and Do/De are sequentially originated from the film frames B,C, and D.

As the television image technology has developed, progressive scan technology is becoming more popular. For example, liquid crystal display (LCD) and plasma television broadcast image data utilizing the progressive scan technology. Progressive scan television displays video image sequences without interlace. Therefore, when the progressive scan television displays traditional odd and even fields, de-interlace is required. When the interlaced fields are de-interlaced, progressive fields can be generated by simply merging adjacent odd fields and the even fields. The step is repeated twice to meet the field rate requirement. Unfortunately, for the movie as shown in FIG. 1, when the third field Ao merges with the fourth field Be, a serious error will result. Ao and Be are not originated from the same frame, so they should not be merged directly.

### SUMMARY OF INVENTION

The main objective of the claimed invention is to provide a method and related field similarity detection for processing video fields to determine the similarity of a plurality of odd and even fields; and also to determine the format of the image signal source according to the similarity of the plurality of fields and to generate image data of another format accurately according to the interlacing fields to overcome the above mentioned problem.

The claimed invention discloses a method of processing an video field, the method comprising: detecting a special pattern of each couple among a plurality of couples of adjacent fields distributed respectively to determine a similarity of said each couple of adjacent fields; and generating a progressive scan television image signal according to a predetermined rule (for example, to generate a frame with each similar couple of fields) when a predetermined pattern is detected (for example, in every alternate couple of fields there will be a similar couple of fields) from said similarities of said adjacent fields; the special pattern, for example, can be a zigzag pattern.

The claimed invention discloses another method of detecting similarity between a couple of adjacent fields, the method comprising the following steps: comparing gray levels between a target pixel of a first field and a plurality of adjacent pixels of a second field to determine if a special pattern exists in the target pixel (for example a zigzag pattern); and accumulating the special pattern to determine if the first field is similar to the second field. The adjacent pixels comprise a first adjacent pixel and a second adjacent pixel, when the gray level of the target pixel is greater than the gray level of the first adjacent pixel surpassing above a second predetermined value, and the gray level of the target pixel is greater than the gray level of the second adjacent pixel surpassing above a third predetermined value, then it is determined that a zigzag exists in the target pixel.

The claimed invention discloses a device for detecting similarity between couples of fields, the device comprising: a pixel comparator for comparing gray levels between a first target pixel of a first field and a plurality of adjacent pixels of a second field to detect if a special pattern exists in the target pixel, for example a zigzag, and the first field and the second field are adjacent fields; an accumulation unit, coupled to the pixel comparator, for accumulating the special pattern of the first field to generate an accumulation result; and a similarity decision unit, coupled to the accumulation unit, for determining whether the first field is similar to the second field according to the accumulation result.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 illustrates a comparison diagram between conventional television fields converted from the film with original film frames.

FIG. 2 illustrates a comparison diagram of progressive television frames generated by a method of processing video fields with original film frames according to the present invention.

FIG. 3 illustrates a diagram of sequential interlacing fields.

FIG. 4 illustrates a method flowchart of detecting similarity between odd field and even field.

FIG. 5 illustrates a circuit diagram of a field similarity detection device according to the preferred embodiment of the present invention.

FIG. 6 illustrates a diagram of interlacing television field formed by computer-animated image.

### DETAILED DESCRIPTION

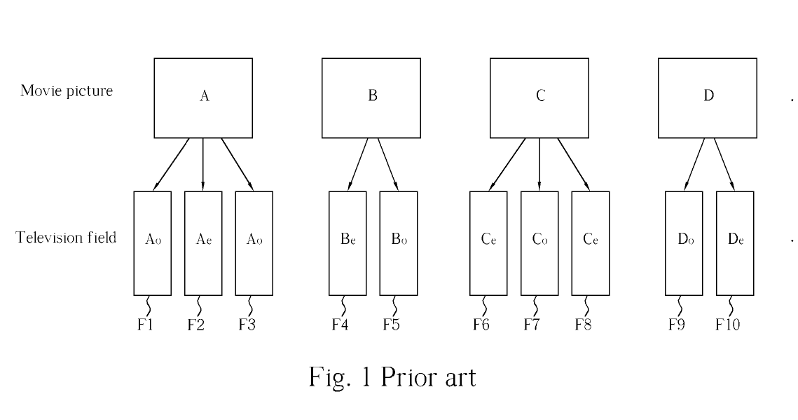

The present invention utilizes field similarity information between couples of adjacent fields to determine the data format of field source in order to properly generating frames of progressive scan. An odd field and an even field originated from the same frame is similar to each other, but an odd field and an even field originated from two different frames are not similar when motion occurs between the two different frames. Relatively, when degree of similarity between the adjacent odd field and even field is greater than the predetermined value, it can be determined that the two adjacent odd field and even field originate from the same frame. For example, as shown in FIG. 1, fields F1 and F2, F2 and F3, and F4 and F5 look similar to each other, separately. Fields F6 and F7, F7 and F8, and F9 and F10 look similar to each other, separately. Therefore, for the film to television conversion, in five successive couples of television fields, fields of a first couple of adjacent fields, a second couple of adjacent fields and a fourth couple of adjacent fields are similar to each other separately, and this pattern repeats. The method of processing video fields of the present invention determines the field source according to the pattern of the field similarity. Preferably, if the predetermined pattern appears for a predetermined number in view of the field similarity, the format source data is then determined and proper image processing can proceed.

For example, in two continuous groups of five successive couples of television fields, the first couple of adjacent fields, the second couple of adjacent fields and the fourth of couple of adjacent fields are similar to each other, then the television fields can be determined as originated from a film.

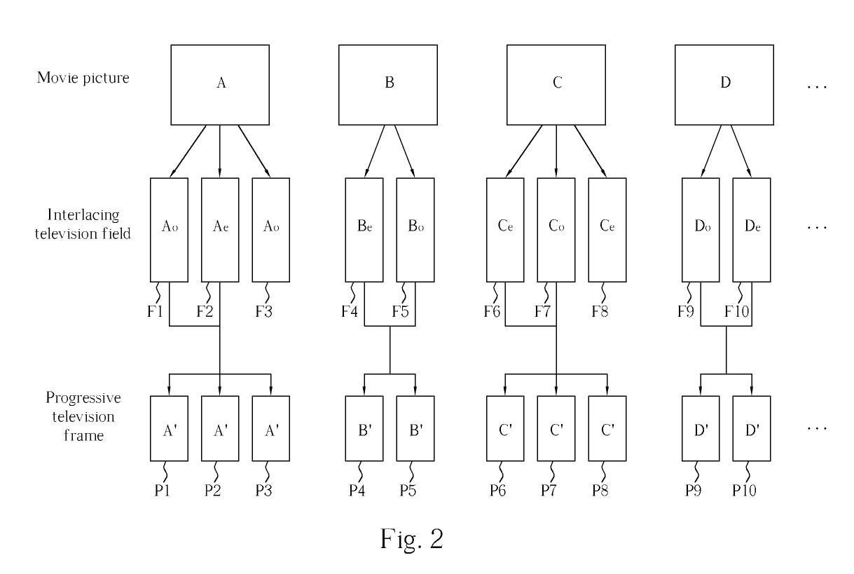

FIG. 2 illustrates a diagram of generating progressive television frames according to the present invention. When television adjacent fields F1 and F2, F2 and F3, and F4 and F5 are detected as similar to each other; and when F6 and F7, F7 and F8, and F9 and F10 are detected as similar to each other, this television fields can be determined as originated from a film. Therefore the odd field F1 and the even field F2 are combined to generate a progressive television frame P1 as required by progressive scan television (for example, liquid crystal display or plasma television). A progressive television frame P1, which is labeled as A′, is preferably generated from an odd field Ao and an even field Ae of film frame A. Similarly, the progressive television frames P4, P6, and P9, labeled as B′, C′, and D′, are generated from the even field F4 and the odd field F5, the even field F6 and the odd field F7, and the odd field F9 and the even field F10, respectively.

The NTSC system defines the field rate as 60 Hz, therefore the progressive television frame P1 is duplicated into progressive television frames P2 and P3 and the progressive television frame A′ is displayed three times. The progressive television frame P4 is duplicated into a progressive television frame P5 and the progressive television frame B′ is displayed twice. Similarly, the progressive television frames P6 and P9 are duplicated to be displayed.

In this embodiment, the determine rule is preferably applicable to the succession of television fields, when a predetermined similarity pattern is detected in a succession of predetermined number of times. For example, a predetermined pattern appears in the similarity of two continuous groups of five couples of adjacent fields. Thereafter, the interlaced fields are deinterlaced into progressive fields. While displaying the progressive fields, the predetermined pattern of similarity is being examined repetitively. When the pattern disappears, the associated data processing should stop. Alternatively, the similarity pattern is being examined periodically.

Every two adjacent fields inevitably have to be an odd field and an even field. However, there are no exactly corresponding pixels of the same coordinates in the two adjacent fields. The present invention discloses a method and a related device for determining similarity between two adjacent fields by detecting zigzags.

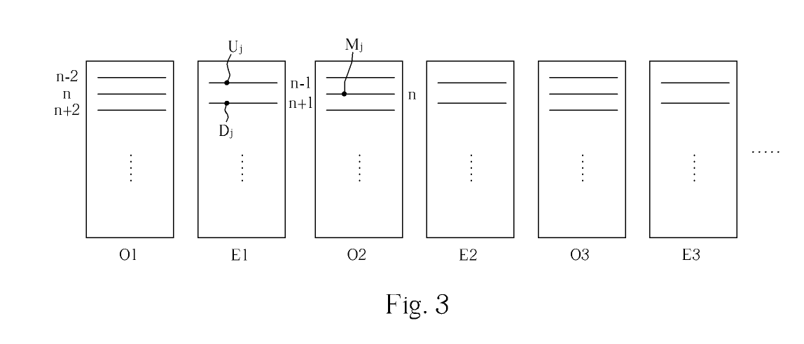

FIG. 3 illustrates a diagram of interlacing fields, including odd fields O1, O2 and O3, and even fields E1, E2 and E3. In this embodiment, in a couple of adjacent fields, comparisons are performed between gray level of each pixel of one field and gray levels of two adjacent pixels above and below on the same horizontal coordinates of another adjacent field. Each comparison result is accumulated to determine whether the two adjacent fields are similar. For example, referring to adjacent fields E1 and O2, when a pixel Mj, the jth pixel at nth row in field O2, is taken as a target pixel, a pixel Uj, the jth pixel at (n−1)th row in field E1, and a pixel Dj, the jth pixel at (n+1)th row in field E1, are compared. The following Mj, Uj and Dj represents gray levels of pixels Mj, Uj and Dj. Preferably, when the following three formulas all stand, a non-smooth change at pixel Mj in the field O2 is determined:
Sign(Mj−Uj)XORSign(Dj−Mj)=1 eq.(1)
Abs(Mj−Uj)>K1 eq.(2)
Abs(Dj−Mj)>K2 eq.(3)

K1 and K2 are two pre-determined values, and can be the same or different.

When two adjacent fields are not similar due to the motion, in three vertical adjacent data rows of the two fields, in the gray level of three pixels on the same horizontal coordinate, the gray level of the pixels can either be maximum or minimum gray of value (satisfy equation (1)) of the three pixels, and differences between gray level of the target pixel and gray level of the two vertical adjacent pixels are greater than the pre-determined value (satisfy equation (2) and equation (3)), then a non-smooth change is determined between the pixel Mj of the pixels and the two vertical adjacent pixels Uj, Dj. When the quantity of the non-smooth change pixels between a target field and its adjacent field is greater than a predetermined value, the two fields are not similar. The two fields are not originated from the same frame. If the quantity of the non-smooth change pixels is less than the predetermined value, the two adjacent fields can be determined as similar. In other words, the two adjacent fields are originated from the same frame.

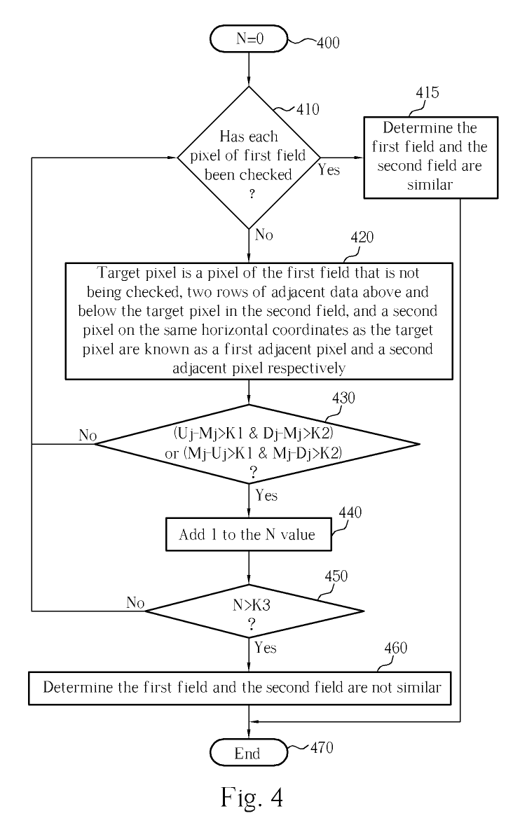

FIG. 4 illustrates a flowchart of a method for detecting a similarity between two adjacent fields, referred to as a first field and a second field.

Step 400: Set N value as 0;

Step 410: If each pixel of the first field is being checked, execute step 415; If not, then execute step 420;

Step 415: Determine the first field and the second field are similar, execute step 470;

Step 420: Target pixel is a pixel of the first field that is not being checked, two rows of adjacent data above and below the target pixel in the second field, and a second pixel on the same horizontal coordinate as the target pixel are known as a first adjacent pixel and a second adjacent pixel respectively;

Step 430: When gray level Uj of the first adjacent pixel is greater than gray level Mj of the target pixel above a first predetermined value K1, and when gray level Dj of the second adjacent pixel is greater than the gray level Mj of the target pixel above a second predetermined value K2; or when the gray level Uj of the first adjacent pixel is smaller than the gray level Mj above the predetermined value K1, and when the gray level Dj of the second adjacent pixel is smaller than the gray level Mj of the target pixel above the predetermined value K2, execute step 440; if not, execute step 410;

Step 440: Increase N value by 1;

Step 450: If the N value is greater than a third predetermined value K3, execute step 460; if the N value is smaller than the third predetermined value K3, return to step 410;

Step 460: Determine the first field and the second field are not similar;

Step 470: End.

To realize the present invention's method of detecting the similarity between the odd field and the even field as shown in FIG. 4, an image-processing device can be realized through software or hardware.

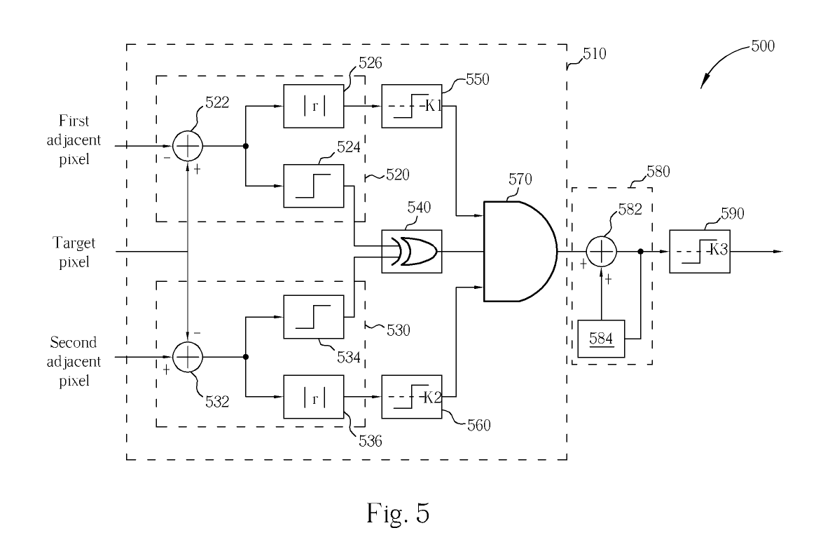

FIG. 5 illustrates a circuit diagram of a field similarity detection device 500 according to the present invention. The device 500 comprises a pixel comparator 510 for comparing similarity of a pixel of a first field and two adjacent pixels of a second field, an accumulation unit 580 and a similarity decision unit 590. The similarity between two adjacent fields is determined. For example, a target pixel is Mth pixel of Nth line in the first field, and two adjacent pixels are exemplified as Mth pixel of N+1th line and Mth pixel of N−1th line of the second field. The pixel comparator 510 comprises two pixel-processing modules 520, 530 for calculating differencees of the target pixel and gray levels of two adjacent pixels. The pixel-processing modules 520, 530 comprise subtractors 522, 532 respectively, for calculating differences of gray level of the target pixel and gray levels of two adjacent pixels, and absolute value units 526, 536 respectively for outputting the absolute value of the difference value, and also sign units 524, 534 respectively for outputting sign information of the difference value. The pixel comparator 510 further comprises an exclusive-or (XOR) gate 540, two comparators 550, 560, and an AND gate 570. The XOR gate 540, coupled to comparators 524, 534 of two pixel processing modules 520, 530, calculates XOR result of the sign information of the two difference values outputted by the pixel-processing modules 520,530. For the two difference values, when one is positive and the other is negative, a logic 1 is outputted in this embodiment. The comparators 550, 560, coupled to the absolute value units 526, 536 of the two pixel-processing modules 520, 530 respectively, for comparing the difference value between the gray level of the target pixel and the two adjacent pixels with the predetermined value. When the differences between the gray level of the target pixel and the gray level of the adjacent pixels are greater than the predetermined values K1, K2, the comparators 550, 560 outputs logic 1. When the difference(s) between the gray level of the target pixel and the gray level of the adjacent pixels is smaller than predetermined value K1, K2, the comparators 550, 560 outputs logic 0. The AND gate 570, coupled to the outputs of the two comparators 550, 560 and the output of XOR 540. The accumulation unit 580, coupled to the output of the AND gate 570, comprises an adder 582 and a buffer 584, for accumulating the non-smooth changes. In this embodiment, if the difference of the gray level of the target pixel and each gray level of the two adjacent pixels is greater than the predetermined value, and if the gray level of the target pixel is either greatest or smallest of the three values, the comparator 510 will output logic 1 to the accumulation unit 580, which represents a zigzag exists at the target pixel. Otherwise, the pixel comparator 510 will output the logic 0 to the accumulation unit 580. Therefore, each pixel of the first field sequentially acts as the target pixel, and, by comparing with the adjacent pixels of the second field, the pixel comparator 510 outputs logic 1 or 0 to the accumulation unit 580. The similarity decision unit 590 is coupled to the output of the accumulation unit 580. When the accumulation result of the accumulation unit 580 is greater than the predetermined value K3, it is determined that the first field is not similar to the second field.

The present invention is capable of determining the similarity pattern of interlaced fields transformed from the movie or from the computer animation source, in order to properly generate progressive fields.

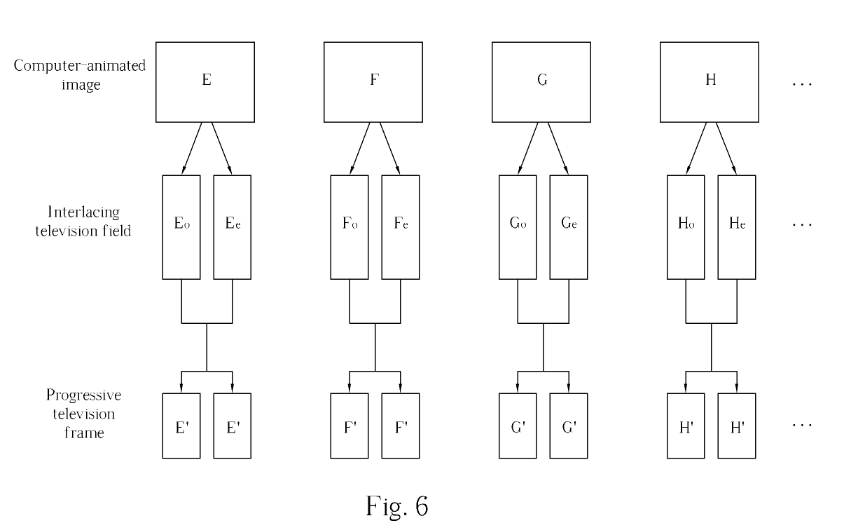

FIG. 6 illustrates a diagram of interlaced television fields from computer-animation source. The computer-animation generates 30 frames per second, therefore when an image-processing device which requires interlacing scanning technology to display computer-animation data under the NTSC specification, each frame of the computer animation is divided into an odd field and an even field. For example, the computer-animated images E, F, G, H respectively generate fields Eo and Ee, Fo and Fe, Go and Ge, Ho and He. When the present invention detects the similarity between the successive couples of adjacent fields, the television fields Eo and Ee, Fo and Fe, Go and Ge, and Ho and He are similar to each other, separately. In other words, in every alternate couple of fields, there will be a couple of similar adjacent fields. According to the characteristic of interlaced television fields originated from the computer animation data, every time when the pattern of in every alternate couple of fields, there will be a couple of similar adjacent fields is detected, the image source data is determined to be the computer-animated image to combine odd field Eo and even field Ee, odd field Fo and even field Fe, odd field Go and even field Ge, and odd field Ho and even field He respectively, and so forth to generate progressive television frames E′, F′, G′ and H′ with complete data volume required by the progressive scan television. In this embodiment, in order to conform to 60 Hz NTSC field rate, each progressive television frame E′, F′, G′ and H′ is displayed twice.

The present invention discloses a method of processing video field for determining format of the source data of the interlacing television fields according to the similar pattern of odd field and even field of each couple of adjacent fields in the interlacing television field sequence, also by combining the interlacing television fields to generate data of progressive field. As long as the format of the interlacing television field source data is recognized, when the source data is converted into the interlacing television field, a similar pattern will be displayed in between each field, the present invention will then convert the interlacing television field generated by the source data into the progressive television field data. The present invention further provides a method of detecting zigzag similarity in between the odd field the even field, and also the comparison of the odd field and the even field sequentially, the duplicate group comprises gray levels of three pixels on the same horizontal coordinates of three rows of adjacent data.

The present invention also reveals a device for detecting similar fields, the device comprising a pixel comparator for comparing gray level change of a first target pixel of a first field and a plurality of adjacent pixels of a second field, to detect whether a special pattern exists in the target pixel, for example a zigzag, and the first field and the second field are adjacent fields; an accumulation unit, coupled to pixel comparator, for accumulating the special pattern of the first field to generate an accumulation result; and a similarity decision unit, coupled to the accumulation unit, for determining whether the first field is similar to the second field according to the accumulation result.

Those skilled in the art will readily observe that numerous modifications and alterations of the device and method may be made while retaining the teachings of the invention. Accordingly, the above disclosure should be construed as limited only by the metes and bounds of the appended claims.

1. A method of processing video field, the method comprising the following steps:
detecting a special pattern of each couple among a plurality of couples of adjacent fields distributed respectively to determine a similarity of said each couple of adjacent fields; and
generating a progressive scan television image signal according to a predetermined rule when a predetermined pattern is detected from said similarities of said adjacent fields.

2. The method of claim 1 wherein the special pattern is a zigzag pattern.

3. The method of claim 1 wherein said each couple of adjacent fields comprises an odd field and an even field.

4. The method of claim 2 wherein said each couple of adjacent fields comprises a target field and a related field, and the detecting step compares gray level variation between a target pixel of the target field and a plurality of adjacent pixels of the related field to determine whether the zigzag exists at the target pixel of the target field.

5. The method of claim 2 wherein in the step of generating progressive scan television image signal, the predetermined pattern indicates that, among the couples of adjacent fields, in every alternate couple of fields a similar couple of adjacent fields exists; and the predetermined rule then generates a frame with each similar couple of adjacent fields, and generate the progressive scan television image signal utilizing the frame.

6. The method of claim 2 wherein every five continuous couples of adjacent fields are in sequence of a first couple of adjacent fields, a second couple of adjacent fields, a third couple of adjacent fields, a fourth couple of adjacent fields, and a fifth couple of adjacent fields; said first couple, said second couple and said fourth couple are respectively similar to each other; and said generating step generates a first frame with said first couple of adjacent fields, a second frame with said fourth couple of adjacent fields, and utilizes said first frame and said second frame to generate the progressive scan television image signal according to the predetermined pattern indicates.

7. The method of claim 2 wherein every five continuous couples of fields are in sequence of a first couple of adjacent fields, a second couple of adjacent fields, a third couple of adjacent fields, a fourth couple of adjacent fields, and a fifth couple of adjacent fields; said first couple, said second couple and said fourth couple are respectively similar to each other while said third couple and said fifth couple are not similar to each other; said generating step generates a first frame with said first couple of adjacent fields, a second frame with said fourth couple of adjacent fields, and utilizes said first frame and said second frame to generate the progressive scan television image signal according to the predetermined rule.

8. The method of claim 2 wherein said detecting step accumulates a quantity of zigzags between a couple of adjacent fields, and said couple of adjacent fields is determined to be different when said quantity of zigzags is greater than a first predetermined value.

9. The method of claim 4 wherein the target pixel and the adjacent pixels are located on a same horizontal coordinate.

10. The method of claim 4 wherein the adjacent pixels comprise a first adjacent pixel and a second adjacent pixel, and it is determined that a zigzag exists at the target pixel of the target field when the gray level of the target pixel is greater than the gray level of the first adjacent pixel surpassing above a second predetermined value and the gray level of the target pixel is greater than the gray level of the second adjacent pixel surpassing above a third predetermined value.

11. The method of claim 4 wherein the adjacent pixels comprise a first adjacent pixel and a second adjacent pixel, and it is determined that a zigzag exists in the target pixel of the target field when the gray level of the target pixel is less than the gray level of the first adjacent pixel surpassing above a second predetermined value, and the gray level the target pixel is less than the gray level of the second adjacent pixel surpassing above a third predetermined value.

12. The method of claim 5 wherein the step of generating progressive scan television image signal utilizes the frame, generated from the similar couple of adjacent fields, to generate progressive scan television image signal by repeating the frame twice.

13. The method of claim 5 wherein the couples of adjacent fields is originated from an interlaced scanning television image signal formed from computer animation.

14. The method of claim 6 wherein the step of generating progressive scan television image signal generates the progressive scanning television image signal by repeating the first frame three times and the second frame twice.

15. The method of claim 7 wherein the step of generating progressive scan television image signal generates the progressive scanning television image signal by repeating the first frame three times and the second frame twice.

16. The method of claim 7 wherein the couples of adjacent fields is originated from an interlaced scanning television image signal formed from movie image data.

17. A method of detecting similarity between a couple of adjacent fields, wherein the couple of adjacent fields comprises a first field and a second field, the method comprising the following steps:
comparing gray levels between a target pixel of the first field and a plurality of adjacent pixels of the second field to determine if a special pattern exists at the target pixel; and
accumulating the special pattern to determine if the first field is similar to the second field.

18. The method of claim 17 wherein the special pattern is a zigzag pattern.

19. The method of claim 17 wherein the first field and the second field are an odd field and an even field respectively.

20. The method of claim 17 wherein the accumulation step generates a statistic value according to the accumulation of the special pattern, and the couple of adjacent fields is determined to be different when the statistic value is greater than a first predetermined value.

21. The method of claim 17 wherein the target pixel and the adjacent pixels are located at a same horizontal coordinate.

22. The method of claim 18 wherein the adjacent pixels comprise a first adjacent pixel and a second adjacent pixel, and it is determined that a zigzag exists in the target pixel when the gray level of the target pixel is greater than the gray level of the first adjacent pixel surpassing above a second predetermined value, and the gray level of the target pixel is greater than the gray level of the second adjacent pixel surpassing above a third predetermined value.

23. The method of claim 18 wherein the adjacent pixels comprise a first adjacent pixel and a second neighbor pixel, and it is determined that a zigzag exists in the target pixel when the gray level of the target pixel is less than the gray level of the first adjacent pixel surpassing above a second predetermined value, and the gray level of the target pixel is less than the gray level of the second adjacent pixel surpassing above a third predetermined value.

24. A device for detecting similarity between couples of fields, the device comprising:
a pixel comparator for comparing gray levels between a first target pixel of the first field and a plurality of adjacent pixels of the second field to detect if a special pattern exists in the target pixel; and
an accumulation unit, coupled to the pixel comparator, for accumulating the special pattern to generate an accumulation result; and
a similarity decision unit, coupled to the accumulation unit, for determining whether the first field is similar to the second field according to the accumulation result.

25. The device of claim 24 wherein the first field is adjacent to the second field.

26. The device of claim 25 wherein the first field and the second field are an odd field and an even field respectively.

27. The device of claim 25 wherein the special pattern is a zigzag pattern.

28. The device of claim 25 wherein the pixel comparator comprises:
a first pixel processing module comprising:
a subtractor for calculating a first difference between a gray level of the target pixel of the first field and a gray level of a first adjacent pixel of the adjacent pixels of the second field;
an absolute value unit, coupled to the subtractor of the first pixel processing module, for outputting an absolute value of the first difference; and
a sign unit, coupled to the subtractor of the first pixel processing module, for outputting a logic 1 as a first sign signal when the first difference is positive, and outputting a logic 0 as the first sign signal when the first difference is not positive;
a second pixel processing module comprising:
a subtractor for calculating a second difference between a gray level of the target pixel of the first field and a gray level of a second adjacent pixel of the adjacent pixels of the second field;
an absolute value unit, coupled to the subtractor of the second pixel processing module, for outputting an absolute value of the second difference; and
a sign unit, coupled to the subtractor of the second pixel processing module, for outputting a logic 1 as a second sign signal when the second difference is positive, and outputting a logic 0 as the second sign signal when the second difference is not positive;
an exclusive or (XOR) gate, coupled to the first pixel processing module and the second pixel processing module, for performing an XOR calculation on the first sign signal and the second sign signal;
a first comparator, coupled to the first pixel processing module, for comparing the absolute value of the first difference and a first predetermined value, wherein a logic 1 will be outputted by the first comparator when the absolute value of the first difference is greater than the first predetermined value, and a logic 0 will be outputted by the first comparator when the absolute value of the first difference is not greater than the first determined value;
a second comparator, coupled to the second pixel processing module, for comparing the absolute value of the second difference and a second predetermined value, wherein a logic 1 will be outputted by the second comparator when the absolute value of the first difference value is greater than the second predetermined value, and a logic 0 will be outputted by the second comparator when the absolute value of the second difference is not greater than the second determined value; and
an AND gate, coupled to the first comparator, the second comparator and the exclusive or gate, for proceeding AND calculation on the output of the first comparator, the output of the second comparator and the output of the XOR gate.

29. The device of claim 28 wherein the similarity decision unit determines the first field and the second field are not similar when the accumulation result of the accumulation unit is greater than a third predetermined value.
